(19) United States
(12) Patent Application Publication
(10) Pub. No.: US 2015/0287314 A1
(43) Pub. Date: Oct. 8, 2015

(54) UNIVERSAL SONIC AND LIGHT EMITTING GROUND FAULT INTERRUPTER MEANS, SYSTEM AND PROCESS

(71) Applicant: David Croft, Aurora, CO (US)

(72) Inventor: David Croft, Aurora, CO (US)

(21) Appl. No.: 14/674,945

(22) Filed: Mar. 31, 2015

Related U.S. Application Data
(60) Provisional application No. 61/972,688, filed on Mar. 31, 2014.

(51) Int. Cl. G08B 21/18

(52) U.S. Cl. CPC G08B 21/185

(57) ABSTRACT

The present inventions comprise novel enhanced universal sonic and light emitting ground fault interrupters (GFI's) or novel enhanced universal and light and sound emitting GFI's (NEU & USE GFI's). Instructions for use of same are also disclosed, as part of a kit.

### CROSS-REFERENCE TO RELATED APPLICATIONS

This application is claims priority to and the benefit of U.S. Provisional Application No. 61/972,688 filed on Mar. 31, 2014, the contents of which are incorporated by reference.

### TECHNICAL FIELD OF THE INVENTION

This invention is related to the area of residual-current devices and ground fault interrupters (GFI's).

### BACKGROUND OF THE DISCLOSURE

This disclosure relates to residual-current devices (RCD's), including residual-current breakers with overload; equipment protection devices; fuses and breakers, circuit breaks and ground wires and appliance ground wires; in particular the present inventions comprise novel enhanced universal sonic and light emitting ground fault interrupters (“GFI's”) or novel enhanced universal and light and sound emitting GFI's.

Reference throughout the specification to “one embodiment,” “an embodiment,” or similar language means that a particular feature, structure, or characteristic described in connection with the embodiment is included in at least one embodiment of the present invention. Thus, appearances of the phrases “in one embodiment,” in an embodiment,” and similar language through the specification may, but not necessarily, all refer to the same embodiment.

Furthermore, the described features, structures, or characteristics of the invention may be combined in any suitable manner in one or more embodiments. In the following description, numerous specific details are provided to provide a thorough understand of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the local flow of the method. For instance, an arrow may indicate a waiting or monitoring period of unspecified duration between enumerated steps of the depicted method. Additionally, the other in which a particular method occurs may or may not strictly adhere to the order of the corresponding steps shown.

### OBJECTS AND SUMMARY OF THE DISCLOSURE

Ground fault interrupters are designed to protect from electrical shock by interrupting a household circuit when there is a difference in the currents in the “hot” and neutral wires. Such a difference indicates that an abnormal diversion of current from the “hot” wire is occurring. Such a current might be flowing in the ground wire, such as a leakage current from a motor or from capacitors. More importantly, that current diversion may be occurring because a person has come into contact with the “hot” wire and is being shocked. When a circuit is functioning normally, all the return current from an appliance flows through the neutral wire, so the presence of a difference between “hot” and neutral currents represents a malfunction which in some circumstances could produce a dangerous or even lethal shock hazard.

The “hot” and neutral wires are passed through the sensing coil so that the currents in the two wires at any instant are traveling in opposite directions, giving a net zero current in the coil if the two currents are exactly equal. Since a current-carrying wire produces an AC magnetic field external to the wire, a non-zero current would induce a voltage in the sensing coil. The sensing coil is wound longitudinally to capture more of the wire's magnetic field and therefore be a more sensitive net current detector. Even so, the difference that it is supposed to detect is quite small. The GFI is designed to trip when there is more than 5 milliamperes of leakage current out of the normal pathway. The neutral return would then have 5 mA less current than the “hot” wire, but that might be out of a 20 A load. So the circuit would have to detect a 0.025% deviation from 20 A return current. Fortunately, comparator circuits such as an op-amp comparator are quite capable of detecting such differences. The voltage in the sensor coil is rectified and applied to the input of the sensitive comparator. The comparator activates a trip coil which opens both the “hot” and neutral wires. If all circuits were wired with correct polarity, opening the “hot” wire would be sufficient, but since it is not uncommon for them to be accidentally wired backward, it is prudent to interrupt both leads.

It is common household practice to wire several receptacles on a given circuit. A single GFI at the circuit panel will protect the entire collection of receptacles since a difference between “hot” and neutral current at any one of them will cause a difference at the GFI. A single GFI at one receptacle would not protect the entire circuit.

Because of the great sensitivity of the detection of current differences, GFIs are prone to nuisance tripping in certain applications. A rather common practice in some areas is to have a freezer on the carport, and carport receptacles are sometimes wired with GFIs. Under moist conditions you can sometimes get enough leakage current to trip the GFI, and persons come back to find their freezer thawed out. A necessary safety precaution in bathrooms and near pools, they are sometimes quite troublesome in outdoor applications where reliable power is needed. The literature contains good discussions of other circumstances which lead to nuisance tripping, particularly with campers and recreational vehicles.

Three electrical connections are made to a standard appliance like a clothes washing machine. The “hot” wire carries an effective voltage of 120 volts to the appliance and the neutral serves as the normal return path. The third wire is the electrical ground which is just connected to the metal case of the appliance.

If the hot wire shorts to the case of the appliance, the 120 volt supply will be applied to the very low resistance path through the ground wire. This will cause an extremely high current to flow and will cause the breaker or fuse to interrupt the circuit.

One problem with this arrangement is that if the ground wire is broken or disconnected, it will not be detectable from the operation of the appliance since the ground wire is not a part of the circuit for electric current flow. In that case, if the hot wire shorts to the case and the neutral wire does not, then the breaker may not trip and the entire 120 volts will be applied to the metal case of the appliance, representing a shock hazard. The ground wire of an appliance is the main protection against shock hazard.

Fuses and breakers limit the current which can flow in a circuit. Generally, a metal filament in the fuse melts and breaks the connection, whereas in a breaker, the heating effect on a bi-metallic strip causes it to bend and trip a spring-loaded switch.

Circuit-Breaker: Circuit breakers act to limit current in a single circuit in most household applications. Single circuits may be limited to 20 amperes, although sizes could be variable to heat bi-metallic strip to be downward and release the spring-load type of lever. Large circuits from short circuits are managed by electromagnets consisting of wire loops around a piece of iron will pull the bi-metallic strip down.

The term “ground” refers to a connection to the earth, which acts as a reservoir of charge. A ground wire provides a conducting path to the earth which is independent of the normal current-carrying path in an electrical appliance. As a practical matter in household electric circuits, it is connected to the electrical neutral at the service panel to gaurantee a low enough resistance path to trip the circuit breaker in case of an electrical fault (see illustration below). Attached to the case of an appliance, it holds the voltage of the case at ground potential (usually taken as the zero of voltage). This protects against electric shock. The ground wire and a fuse or breaker are the standard safety devices used with standard electric circuits.

The appliance will operate normally without the ground wire because it is not a part of the conducting path which supplies electricity to the appliance. In fact, if the ground wire is broken or removed, you will normally not be able to tell the difference. But if high voltage has gotten in contact with the case, there may be a shock hazard. In the absence of the ground wire, shock hazard conditions will often not cause the breaker to trip unless the circuit has a ground fault interrupter in it. Part of the role of the ground wire is to force the breaker to trip by supplying a path to ground if a “hot” wire comes in contact with the metal case of the appliance.

In the event of an electrical fault which brings dangerous high voltage to the case of an appliance, you want the circuit breaker to trip immediately to remove the hazard. If the case is grounded, a high current should flow in the appliance ground wire and trip the breaker. That's not quite as simple as it sounds—tying the ground wire to a ground electrode driven into the earth is not generally sufficient to trip the breaker, which was surprising to me. The U.S. National Electric Code Article 250 requires that the ground wires be tied back to the electrical neutral at the service panel. So in a line-to-case fault, the fault current flows through the appliance ground wire to the service panel where it joins the neutral path, flowing through the main neutral back to the center-tap of the service transformer. It then becomes part of the overall flow, driven by the service transformer as the electrical “pump”, which will produce a high enough fault current to trip the breaker. In the electrical industry, this process of tying the ground wire back to the neutral of the transformer is called “bonding”, and the bottom line is that for electrical safety you need to be both grounded and bonded.

### BRIEF DESCRIPTION OF THE FIGURES

FIG. 1 shows a rear perspective view of the device, according to the instant teachings.

FIG. 2 shows a top-down left side perspective view of the device, according to the instant teachings.

FIG. 3 shows a top-down right side perspective view of the device, according to the instant teachings.

FIG. 4 shows a wiring schematic of the device, according to the instant teachings.

### DETAILED DESCRIPTION OF THE DISCLOSURES

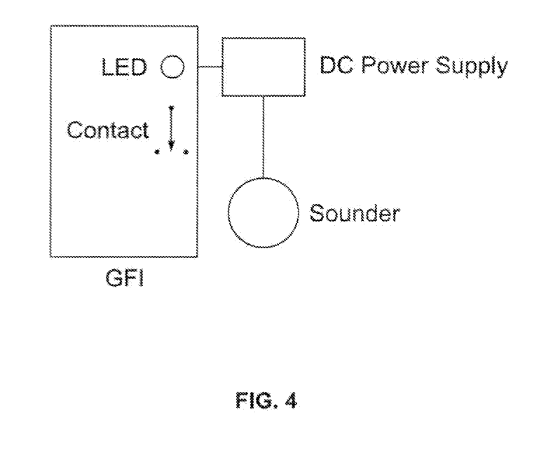

The present disclosure, referring to FIG. 4, showing the functional elements, enables sonification and red LED indicators.

The present inventor has discovered that existing GFI units are not available with either sounds or LED lights. By implementing a units with at least the same, audio sound and red LED light issue when the test button trips the normal state of the subject GFI unit.

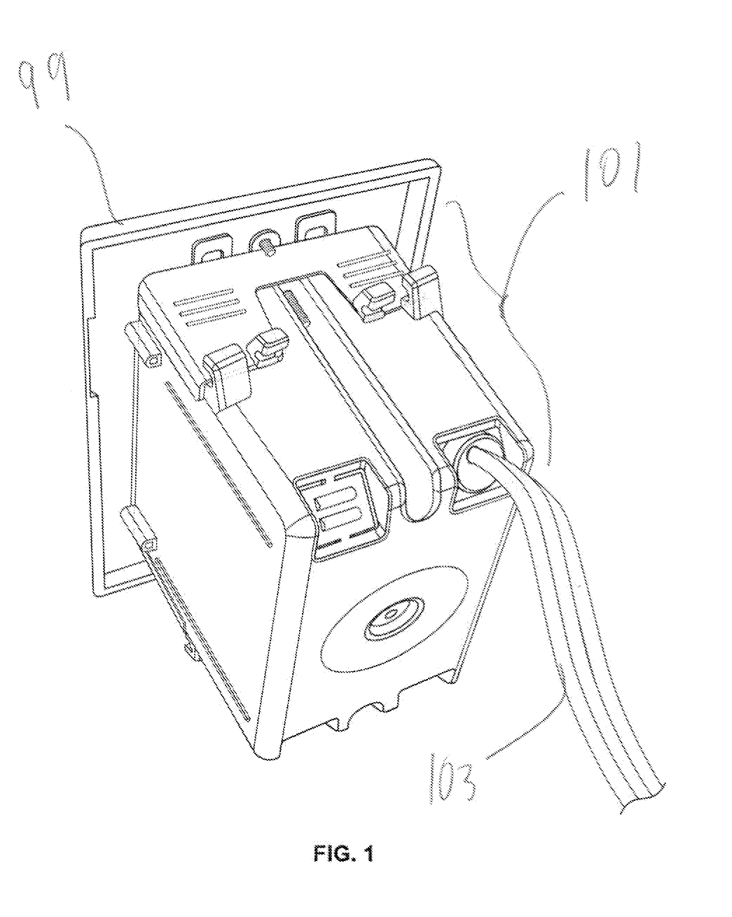

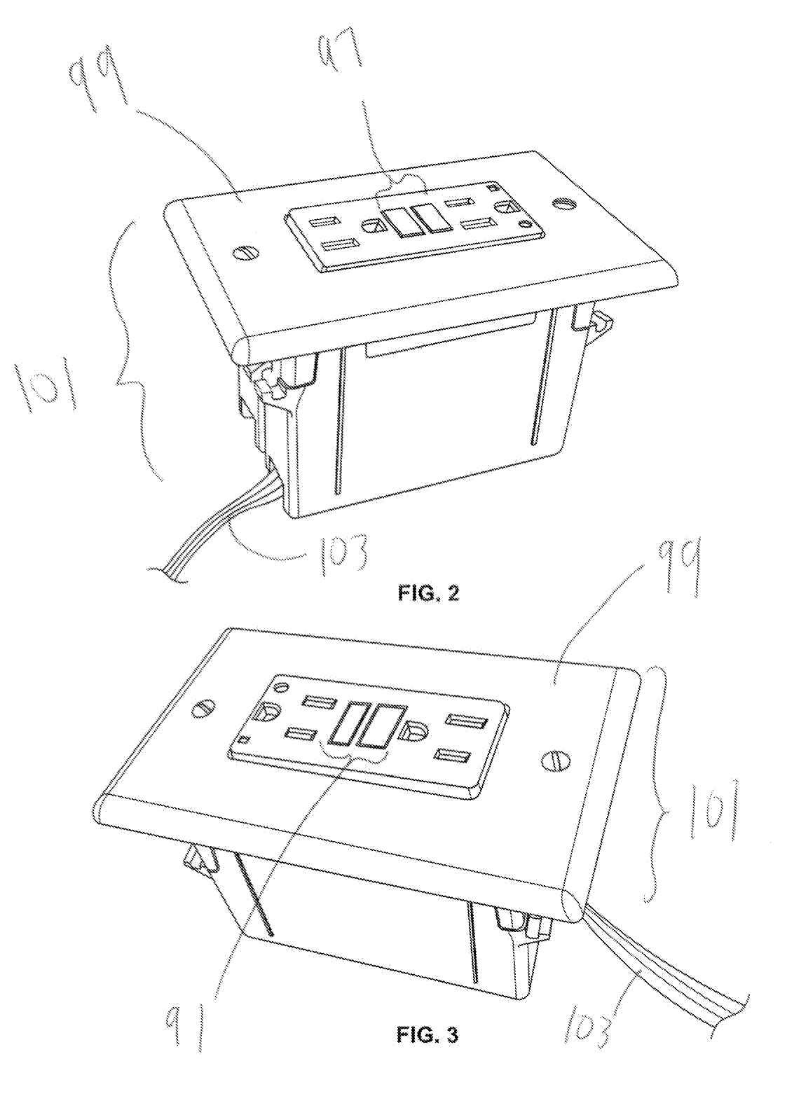

Referring now to FIGS. 1 through 4, and particularly to FIG. 1, prototype of the instant teachings 101 is shown as typically to be installed with rectangular beveled face plate 99, as known to those of skill in the art. AC power source is connected to cord 103. Referring also to FIG. 2, rectangular beveled face plate 99 is hooked to power outlets and has test button 97 (shown in a first or extended state). In FIG. 3, test buttons are shown in a depressed state.

Those skilled in the art understand how sonification and LED activation are triggered, as shown in schematic FIG. 4.

Circuit-Breaker: Circuit breakers act to limit current in a single circuit in most household applications. Single circuits may be limited to 20 amperes, although sizes could be variable to heat bi-metallic strip to be downward and release the spring-load type of lever. Large circuits from short circuits are managed by electromagnets consisting of wire loops around a piece of iron will pull the bi-metallic strip down.

The term “ground” refers to a connection to the earth, which acts as a reservoir of charge. A ground wire provides a conducting path to the earth which is independent of the normal current-carrying path in an electrical appliance. As a practical matter in household electric circuits, it is connected to the electrical neutral at the service panel to gaurantee a low enough resistance path to trip the circuit breaker in case of an electrical fault (see illustration below). Attached to the case of an appliance, it holds the voltage of the case at ground potential (usually taken as the zero of voltage). This protects against electric shock. The ground wire and a fuse or breaker are the standard safety devices used with standard electric circuits.

The appliance will operate normally without the ground wire because it is not a part of the conducting path which supplies electricity to the appliance. In fact, if the ground wire is broken or removed, you will normally not be able to tell the difference. But if high voltage has gotten in contact with the case, there may be a shock hazard. In the absence of the ground wire, shock hazard conditions will often not cause the breaker to trip unless the circuit has a ground fault interrupter in it. Part of the role of the ground wire is to force the breaker to trip by supplying a path to ground if a “hot” wire comes in contact with the metal case of the appliance.

In the event of an electrical fault which brings dangerous high voltage to the case of an appliance, you want the circuit breaker to trip immediately to remove the hazard. If the case is grounded, a high current should flow in the appliance ground wire and trip the breaker. That's not quite as simple as it sounds—tying the ground wire to a ground electrode driven into the earth is not generally sufficient to trip the breaker, which was surprising to me. The U.S. National Electric Code Article 250 requires that the ground wires be tied back to the electrical neutral at the service panel. So in a line-to-case fault, the fault current flows through the appliance ground wire to the service panel where it joins the neutral path, flowing through the main neutral back to the center-tap tap of the service transformer. It then becomes part of the overall flow, driven by the service transformer as the electrical “pump”, which will produce a high enough fault current to trip the breaker. In the electrical industry, this process of tying the ground wire back to the neutral of the transformer is called “bonding”, and the bottom line is that for electrical safety you need to be both grounded and bonded.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

What is claimed is:

1. An apparatus for ground fault interruption means which comprises, in combination:
a first means for creating an alternating sound and visible light spectrum to indicate tripping of said subject ground fault interruption means.

2. The apparatus of claim 1, further comprising an LED projecting a red color.

3. The apparatus of claim 2, further comprising at least a single gang plastic electrical box (residential installment type) and connecting means for an alternating current (AC) electrical cord connection and empowerment; wherein at least audible sound and red LED light are emitted when the ground fault interruption means is tripped.

4. The apparatus of claim 1 further comprising a test button configured to trip the ground fault interruption means.

5. The apparatus of claim 1 further comprising a means to reset the ground fault interruption means from a tripped state to an un-tripped state.

6. A system for novel enhanced universal and sound and light emitting Ground Fault Interrupters, comprising, in combination:
a rectangular beveled face plate mounted over an internal plug-receiving outlet having apertures disposed about at a test trip rectangular button-means and a reset rectangular button-means.

7. A kit, including novel enhanced universal and sound and light emitting GFI's, and instructions for use.
